(19) United States
(12) Patent Application Publication
(10) Pub. No.: US 2005/0082913 A1
(43) Pub. Date: Apr. 21, 2005

(54) Vehicle antitheft system

(76) Inventor: Hiroaki Nomura, Yokkaichi-shi (JP)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/966,429

(22) Filed: Oct. 15, 2004

(30) Foreign Application Priority Data
Oct. 20, 2003 (JP) 2003-359409

(51) Int. Cl. B60L 3/00

(52) U.S. Cl. 307/10.1

(57) ABSTRACT

A vehicle antitheft system capable of safely stopping a vehicle after being stolen. The vehicle antitheft system monitors the state of the vehicle by means of an antitheft control apparatus using a shock sensor, a door sensor, and others which are installed in the vehicle. If an illegal act against the vehicle is detected, an alarm is set off to the outside by means of a siren, a lamp, and the like. When a speed reduction command is received from a hand-held controller outside the vehicle, an injector control relay is controlled so as to stop an operation signal to an injector, and thereby to stop the fuel supply to the engine. Thus, the vehicle is forcibly slowed down to travel at a predetermined speed limit (for example, 30 km/hr) or lower.

### BACKGROUND OF THE INVENTION

(i) Field of the Invention

The present invention relates to a vehicle antitheft system installed in a vehicle for monitoring whether or not any illegal act is committed against the vehicle, and thereby preventing theft of the vehicle.

(ii) Background Art

There is a known vehicle antitheft system installed in a vehicle that monitors the state of the vehicle during the parking of the vehicle, detects an illegal act committed against the vehicle, and sets off an alarm around the vehicle, if an illegal act committed against the vehicle has been detected, to prevent theft of the vehicle.

A vehicle antitheft system of this type, however, is designed to operate with respect to an illegal act during the parking of the vehicle, and is ineffective while the vehicle is running or is temporarily stopped.

Therefore, there has been provided a vehicle antitheft system that, if a vehicle is stolen, forcibly stops the engine and makes it impossible to restart the engine while the vehicle is stopped, or stops the fuel supply to the engine to forcibly stop the vehicle while the vehicle is running, by means of remote control, in order to facilitate locating and recovering the stolen vehicle (see Publication of Unexamined Japanese Patent Application No. 2000-318576).

### SUMMARY OF THE INVENTION

Such a conventional vehicle antitheft system, however, involves the following problems, for example: An operator of the vehicle antitheft system, who cannot know the current running condition of the vehicle, stops the engine and precludes the running of the vehicle that is driving down a road, resulting in obstructing traffic of other vehicles, or stops the fuel supply to the engine while the vehicle is running at a high speed and makes the running condition of the vehicle unstable, thereby causing an accident.

The present invention, which has been made in view of these problems, has an object to provide a vehicle antitheft system capable of safely stopping a vehicle after the vehicle is stolen.

The above and other objects are attained by a vehicle antitheft system of the present invention, in which a monitoring device installed in a vehicle monitors the state of the vehicle to detect an illegal act committed against the vehicle. If the monitoring device detects an illegal act committed against the vehicle, an alarm device sets off an alarm to the surroundings.

When a reception device receives a speed reduction command transmitted from a command apparatus outside the vehicle, a vehicle speed limit device makes a speed reduction device operate to forcibly reduce the speed of the vehicle regardless of the original vehicle operation by a driver, and thereby limits the speed of the vehicle to a predetermined vehicle speed limit or lower.

According to the vehicle antitheft system of the present invention, therefore, even after the vehicle is stolen, it is possible to limit the vehicle speed to the vehicle speed limit or lower by sending a speed reduction command to the reception device from the outside of the vehicle. If the vehicle speed limit is previously set to a speed that allows the vehicle to run safely but is not sufficient for normal use (for example, 30 km/hr), a vehicle thief who cannot achieve sufficient driving may stop the vehicle in a safe manner.

The vehicle antitheft system of the present invention may be constituted so as to prevent a dangerous situation of the vehicle due to a sudden speed reduction by the speed reduction device.

Specifically, the vehicle speed limit device controls the speed reduction device by setting at least one intermediate vehicle speed limit, when an initial vehicle speed at the time of receiving the speed reduction command by the reception device is higher than the vehicle speed limit by a specified amount or more, between the initial vehicle speed and the vehicle speed limit, and by stopping the speed reduction device when the vehicle speed becomes lower than the intermediate vehicle speed limit during a specified period of time since the vehicle speed reaches the intermediate vehicle speed limit, so that the vehicle speed is gradually lowered from the initial vehicle speed through the intermediate vehicle speed limit to the vehicle speed limit.

According to the vehicle antitheft system of the present invention, therefore, it is possible to safely slow down the vehicle without excessively reducing the speed since speed reduction is not performed during the specified period of time since the vehicle speed reaches the intermediate vehicle speed limit.

The speed reduction device may be embodied in various forms, such as operating brakes to slow down the vehicle and lowering the power generated by a power source. In the case of a vehicle provided with an internal-combustion engine as the power source, the speed reduction device may be constituted so as to forcibly slow down the vehicle by stopping the fuel supply to the internal-combustion engine.

According to the constitution, the speed reduction device may easily be installed in a vehicle which is not originally provided with such a speed reduction device, and thus installation of the vehicle antitheft system can be facilitated.

The vehicle antitheft system may be constituted such that while the vehicle is being slowed down by the operation of the speed reduction device, the vehicle speed limit device monitors the revolving speed of the internal-combustion engine and stops the operation of the speed reduction device when the revolving speed is lower than a predetermined minimum revolving speed, thereby to prevent the revolving speed of the internal-combustion engine from being lowered than the predetermined minimum revolving speed.

According to the constitution, it is possible to prevent a dangerous situation of the traveling of the vehicle caused by the internal-combustion engine being stopped due to an excessive speed reduction by the speed reduction device.

In the vehicle antitheft system, a displacement of the vehicle may be detected as the state of the vehicle to be monitored by the monitoring device in order to detect, for example, lifting of the vehicle by a wrecker to steal the vehicle.

In a conventional vehicle antitheft system, however, only a displacement along one axis, i.e., in the forward and backward direction, is detected as a displacement when a vehicle is lifted by a wrecker.

In the vehicle antitheft system of the present invention, the monitoring device may include a three-axis sensor for detecting a displacement of the vehicle as one of the sensors for monitoring the state of the vehicle. If a displacement of the vehicle is detected by the three-axis sensor, the monitoring device determines that an illegal act has been committed and outputs a detection signal indicating the detection of the illegal act to the alarm device.

According to the constitution, it is possible to detect various changes in the state of the vehicle, such as being tilted by jacking-up to steal tires, other than being lifted by a wrecker. Thus, an illegal act can be easily detected.

In another aspect of the present invention, there is provided a command apparatus provided with a transmission device that transmits various command signals from the outside of a vehicle to the above vehicle antitheft system. The command apparatus comprises a speed reduction command generating device that generates a speed reduction command to the vehicle antitheft system corresponding to the command apparatus in accordance with an external operation by a user, and makes the transmission device transmit the speed reduction command.

According to the command apparatus of the present invention, it is possible to make the vehicle speed limit device of the above vehicle antitheft system operate so as to limit the speed of the vehicle to the vehicle speed limit or lower.

In a further aspect of the present invention, there is provided a program that performs the function of the speed reduction command generating device in the above command apparatus by means of the processing by a microcomputer constituting an information terminal having the function as the transmission device.

According to the above program, the command apparatus may be constituted by using a general-purpose microcomputer instead of providing an exclusive apparatus.

### BRIEF DESCRIPTION OF THE DRAWINGS

A preferred embodiment of the present invention will be described hereinafter with reference to the drawings, in which:

FIG. 1 is a diagram showing the entire constitution of the present embodiment;

FIG. 2 is a block diagram showing the constitution of an antitheft control apparatus of the present embodiment;

FIG. 3 is a flowchart of the alarming process in an arithmetic control unit of the present embodiment;

FIG. 4 is a flowchart of the process in a control unit of the present embodiment;

FIG. 5 is a flowchart of the external command monitoring process in the arithmetic control unit of the present embodiment;

FIG. 6 is a flowchart of the vehicle speed control process in a vehicle speed arithmetic control unit of the present embodiment; and

FIG. 7 is a diagram illustrating the behavior of a vehicle when the vehicle speed is controlled by the antitheft control apparatus of the present embodiment.

### DETAILED DESCRIPTION OF THE PREFERRED EMBODIMENT

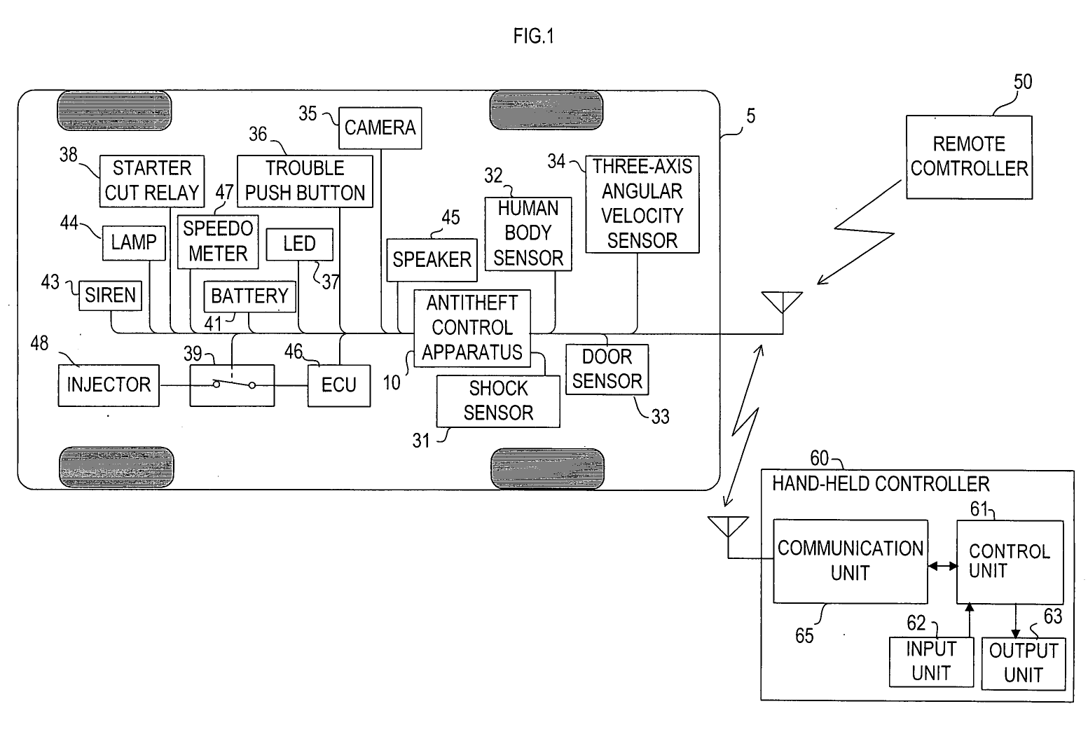

Pertaining to FIG. 1, the vehicle antitheft system 1 is provided with a shock sensor 31, a human body sensor 32, a door sensor 33, and a three-axis angular velocity sensor 34 disposed at appropriate positions in the vehicle 5 to detect an illegal act against the vehicle 5; a camera 35, a starter cut relay 38, an injector control relay 39, and a siren 43 disposed at appropriate positions in the vehicle 5 to prevent theft if an illegal act is detected; and the antitheft control apparatus 10 connected with the above components. The vehicle antitheft system 1 is also provided with a remote controller 50 and a hand-held controller 60 that transmits a command to the antitheft control apparatus 10 from the outside of the vehicle 5.

Also, a trouble push-button 36 and an LED 37 connected to the antitheft control apparatus 10 are provided in the vehicle 5.

In addition, a battery 41, lamps 44, a speaker 45, an engine ECU 46 and a speedometer 47 as the components of the vehicle 5 are connected to the antitheft control apparatus 10.

The battery 41 is provided to supply electric power to electric components installed in the vehicle 5, and its voltage is detected by the antitheft control apparatus 10.

The lamps 44, including head lights, hazard lamps and break lamps of the vehicle 5, are turned on and off by the antitheft control apparatus 10.

The speaker 45 includes an audio speaker of the vehicle 5 that generates sound in accordance with an audio signal from the antitheft control apparatus 10.

The engine ECU 46, which is an electronic control unit for controlling the operation of the engine of the vehicle 5, obtains engine revolutions and outputs a drive command to an injector 48 injecting fuel into the engine so as to obtain a driving force corresponding to accelerator operation. Then, the engine ECU 46 outputs the obtained engine revolutions to the antitheft control apparatus 10.

The speedometer 47, which is designed to detect the vehicle speed from, for example, the rotation number of an axle and indicates the vehicle speed to a driver, outputs the detected vehicle speed to the antitheft control apparatus 10.

The shock sensor 31, as one of the components of the vehicle antitheft system 1, includes a piezoelectric element for detecting a shock and is attached to, for example, a vehicle window to detect a shock caused when the window is broken.

The human body sensor 32, which includes a sensor for detecting an infrared ray emitted from a human body, is disposed at a position overlooking the vehicle interior to detect that a human is present in the vehicle interior.

The door sensor 33, which includes a limit switch and the like, is disposed at an opening/closing portion of the door of the vehicle 5 to detect the opened/closed condition of the door.

The three-axis angular velocity sensor 34, which includes a gyroscope for measuring angular velocities around three axes in the longitudinal direction, the lateral direction and the vertical direction, detects the angular velocities with respect to the three axes when the vehicle 5 is tilted.

The camera 35, which includes a device for taking an image such as a CCD camera, is disposed, for example, on the ceiling of the vehicle interior at a position overlooking the vehicle interior and outputs an image signal of a taken image of the vehicle interior.

The injector control relay 39, which includes a member for connecting and disconnecting a wiring path, such as a relay, is provided in the middle of the wiring from the engine ECU 46 to the injector 48 to disconnect the wiring path in an ON state in which a command voltage from the antitheft control apparatus 10 is applied. The injector control relay 39 connects the wiring path in an OFF state in which a command voltage from the antitheft control apparatus 10 is not applied.

The starter cut relay 38, which includes a member for connecting and disconnecting a wiring path, such as a relay, is provided in the middle of the wiring from the ignition key switch to the starter motor of the vehicle 5 to operate in the same manner as the injector control relay 39 in accordance with a command voltage from the antitheft control apparatus 10.

The siren 43, which includes a member for producing a large volume of alarm sound to the outside, produces an alarm sound in accordance with a command signal from the antitheft control apparatus 10.

The trouble push-button 36 includes a switch or the like whose contact is closed when the button is pushed down. The opened/closed state of the switch is detected by the antitheft control apparatus 10.

The LED 37, which is disposed at a position that is visible to a driver, such as a center console, is lit in accordance with a command signal from the antitheft control apparatus 10 to indicate whether or not the antitheft control apparatus 10 is in an “alarm mode.”

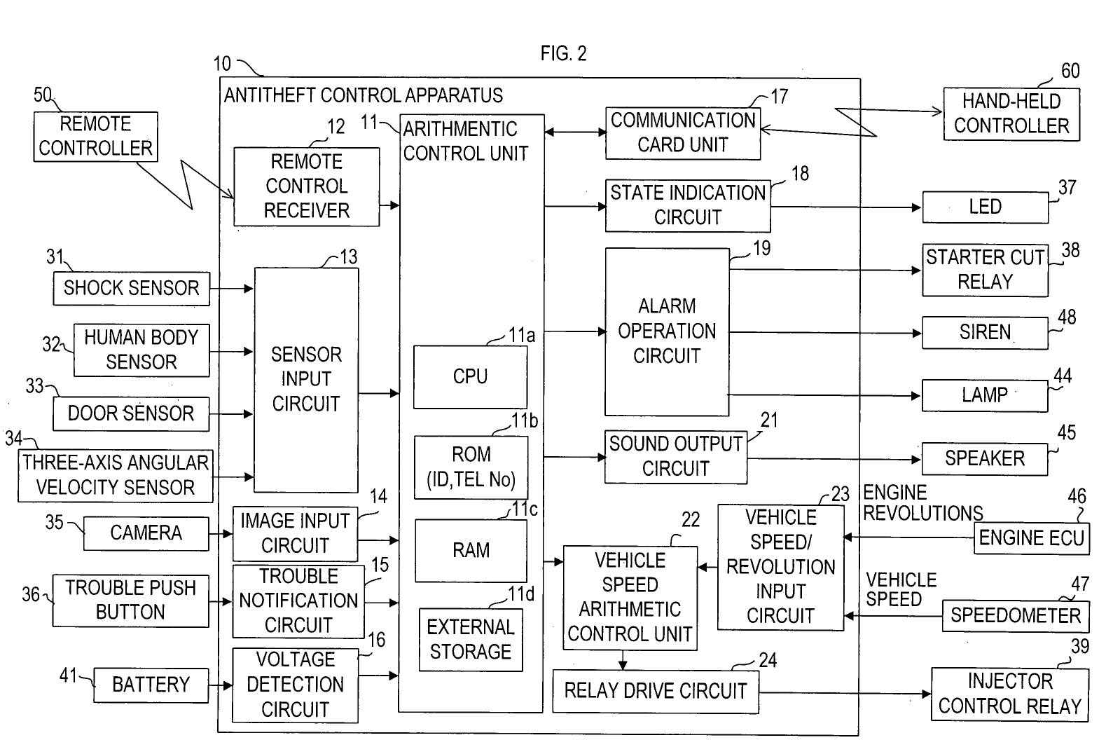

As shown in FIG. 2, the antitheft control apparatus 10 is provided with an arithmetic control unit 11, a remote control receiver 12, a sensor input circuit 13, an image input circuit 14, a trouble notification circuit 15, a voltage detection circuit 16, a communication card unit 17, a state indication circuit 18, an alarm operation circuit 19, a sound output circuit 21, a vehicle speed arithmetic control unit 22, a vehicle speed/revolution input circuit 23, and a relay drive circuit 24.

The remote control receiver 12 receives a radio signal wave from the remote controller 50, extracts a command signal from the received signal wave, and provides the command signal to the arithmetic control unit 11.

The sensor input circuit 13 converts the outputs from the shock sensor 31, the human body sensor 32, the door sensor 33 and the three-axis angular velocity sensor 34 into signals with appropriate levels for inputs into the arithmetic control unit 11, and then provides the signal to the arithmetic control unit 11.

The image input circuit 14 converts an image signal from the camera 35 so as to have an appropriate signal level for an input into the arithmetic control unit 11, and then provides the signal to the arithmetic control unit 11.

The trouble notification circuit 15 generates a signal indicating an opened/closed state of the switch of the trouble push-button 36, and then provides the signal to the arithmetic control unit 11.

Once the arithmetic control unit 11 detects that the trouble push-button 36 has been pushed down, the arithmetic control unit 11 transmits a signal for calling for help from the communication card unit 17 to the hand-held controller 60, the police and others.

The voltage detection circuit 16 detects the voltage of the battery 41, and provides the voltage value to the arithmetic control unit 11.

The communication card unit 17, which includes a PHS (Personal Handyphone System) telephone, communicates with the outside by being connected through the audio line of the PHS.

The state indication circuit 18 lights the LED 37 in accordance with a command signal from the arithmetic control unit 11.

The alarm operation circuit 19, which is designed to switch the power supply to the starter cut relay 38, the siren 43, and the lamp 44, supplies power and drives each of them when a driving command from the arithmetic control unit 11 is received.

The sound output circuit 21 is designed to output the sound signal from the arithmetic control unit 11 as sound through the speaker 45.

The vehicle speed/revolution input circuit 23 is designed to obtain the revolutions of the engine from the engine ECU 46 and the vehicle speed from the speedometer 47, and provide the same to the vehicle speed arithmetic control unit 22.

The vehicle speed arithmetic control unit 22, which includes a 1-chip microcomputer, or the like, receives a command signal from the arithmetic control unit 11 as well as an information signal from the vehicle speed/revolution input circuit, outputs a driving signal and controls the operation of the relay drive circuit 24.

When a driving signal is input from the vehicle speed arithmetic control unit 22, the relay drive circuit 24 applies a command voltage to the injector control relay 39, and thereby switches on/off the wiring path in which the injector control relay 39 is disposed.

The arithmetic control unit 11, which includes a CPU 11a, a ROM 11b, a RAM 11c and an external storage 11d, receives outputs from various devices connected to the antitheft control apparatus 10 and controls the operation of the devices.

The ROM 11b is provided with a rewritable area, in which a target telephone number for communicating with the outside of the vehicle 5 through the communication card unit 7, an ID number and others are stored.

The remote controller 50, which is designed to transmit predetermined signals to the remote control receiver 12 by using radio waves, transmits signals to set the antitheft control apparatus 10 in an “alarm mode” and to release the “alarm mode.”

The hand-held controller 60 is provided with a communication unit 65 for transmitting/receiving signals to/from the antitheft control apparatus 10, an input unit 62 for inputting operation commands by a user, an output unit 63 for indicating information to the user and a control unit 61 for controlling these units.

The control unit 61, the input unit 62 and the output unit 63 are constituted by using a common mobile information terminal such as a PDA (Personal Digital Assistance). Specifically, the CPU inside the PDA, the keys and the touch panel, and the display respectively correspond to the control unit 61, the input unit 62, and the output unit 63.

The communication unit 65, which is constituted by devices for performing data communication through mobile telephones or telephone lines, such as a telephone line modem, performs data communication with the communication card unit 17 of the antitheft control apparatus 10.

The communication between the communication unit 65 and the communication card unit 17 is performed by using a telephone audio line through PHS telephone network, and by connecting the communication lines by PPP (Point to Point Protocol) connection. When establishing the PPP connection, authentication of a communication partner is performed and communication only with partners registered in the ROM 11b of the arithmetic control unit 11 is allowed.

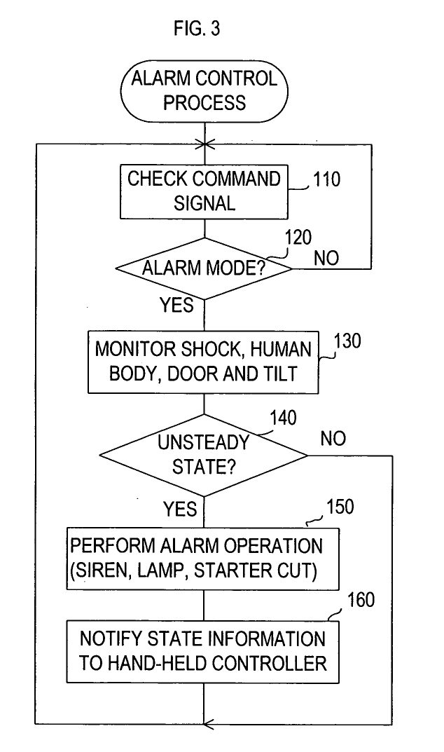

Next, monitoring process by the arithmetic control unit 11 in order to prevent theft of the parked vehicle 5 will be described with reference to the flowchart of FIG. 3.

First, a command signal received by the remote control receiver 12 is checked. If the command signal is a signal to instruct setting of an “alarm mode”, a flag indicating “alarm mode”, for example, is set.

In contrast, if the command signal is a signal to instruct release of the “alarm mode”, the “alarm mode” is released by, for example, resetting the flag (S110). In the case of the “alarm mode”, an indication command is output to the state indication circuit 18 to light the LED 37 indicating that the “alarm mode” is on.

Then, in the “alarm mode” (S120: YES), values of signals detected by the shock sensor 31, the human body sensor 32, the door sensor 33, and the three-axis angular velocity sensor as well as the voltage value of the battery 41 are compared, respectively, with determination reference values prescribed as values that cannot be reached in a normal parked state of the vehicle. If any of these values exceeds the corresponding determination reference values, it is indicated that the vehicle is in an “unsteady state” by, for example, setting an unsteady state flag (S130). Once the determination of an “unsteady state” is made, the “unsteady state” will be maintained until a release command is received from the remote controller 50.

When the determination of an “unsteady state” is made (S140: YES), a command to perform alarm operation is provided to the alarm operation circuit 19. This results in sounding the siren 43, flashing the lamp 44 and producing a warning sound through the speaker, when necessary, thereby giving a warning to a person who caused the “unsteady state.” Also, the starter cut relay 38 is operated so as to stop the starter and thereby to prevent the vehicle 5 from being stolen. In addition, an image signal from the image input circuit 14 is stored in the external storage 11d of the arithmetic control unit 11 in order to record an image of a vehicle thief (S150).

Then, a command is output to the communication card unit 17 to transmit the state information notifying the “unsteady state” to the hand-held controller 60 (S160).

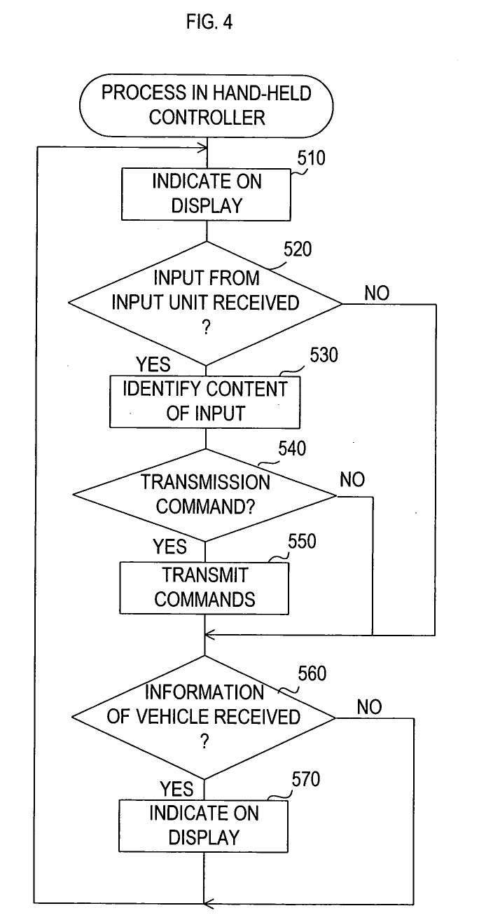

The processing operation in the hand-held controller 60 will now be described with reference to the flowchart in FIG. 4.

First, the state information of the vehicle 5 received by the communication unit 65 and an image for instructing operations to the vehicle 5 are indicated on the output unit 63 (S510).

Subsequently, it is determined whether or not an operation command has been input from the input unit 62 (S520). If it is determined that an operation command has been input (S520: YES), the content of the operation command is identified. If it is identified that the operation command is a transmission command to the antitheft control apparatus 10 (S540: YES), a command is provided to the communication unit 65 to transmit commands to the communication card unit 17 of the antitheft control apparatus 10 (S550). The commands to be transmitted include a command to require notification of the state of the vehicle, a command to perform an alarm operation and a command to limit the vehicle speed.

Then, it is determined whether or not any information is received from the vehicle 5. If it is determined that information has been transmitted from the vehicle 5 (S560), the transmitted information is indicated on the display of the output unit 63 (S570).

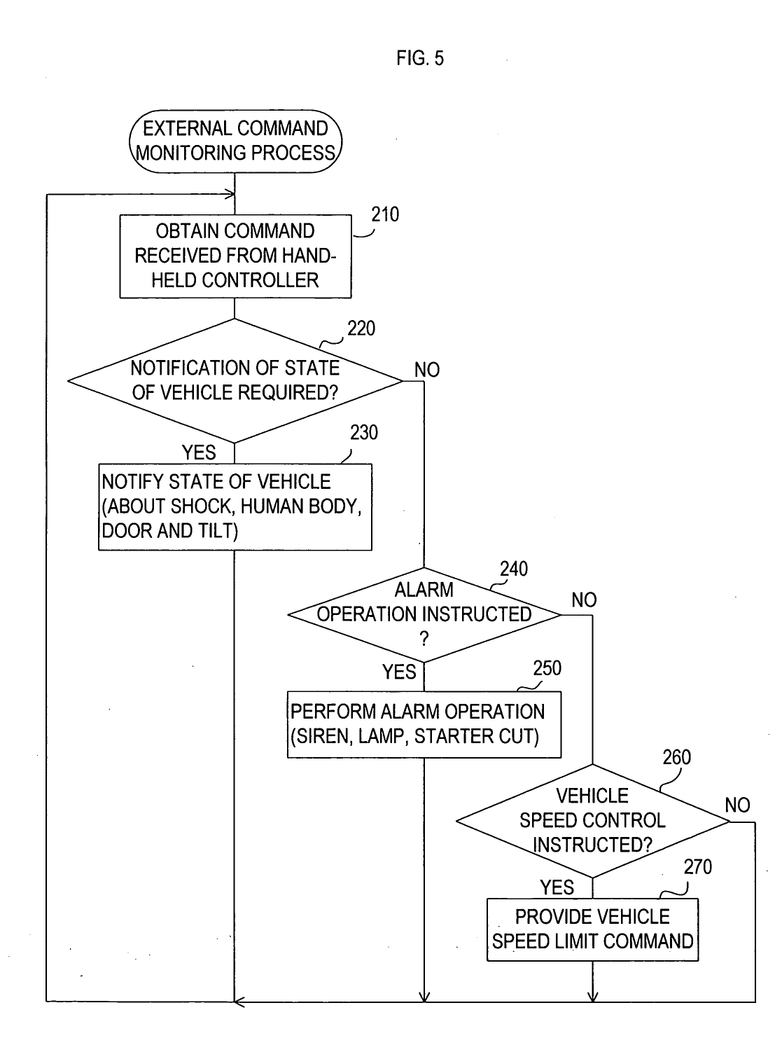

Next, the processing in the arithmetic control unit 11 when a command from the hand-held controller 60 is received will be described with reference to the flowchart in FIG. 5.

First, the command received from the hand-held controller 60 is obtained (S210). If the obtained received command is a signal which requires notification of the state of the vehicle (S220: YES), state signals indicating presence or absence of an abnormal shock, presence or absence of a response of the human body sensor, presence or absence of door opening/closing and presence or absence of tilt of the vehicle are generated in accordance with the values of the respective sensors, output to the communication card unit 17, and transmitted to the hand-held controller 60.

If the received command is a signal instructing alarm processing (S240: YES), a command to perform alarm operation is output to the alarm operation circuit 19, and the same processing as in S150 is performed.

If the received command is a command to perform vehicle speed control (S260: YES), a vehicle speed limit command to limit the vehicle speed is provided to the vehicle speed arithmetic control unit 22 (S270).

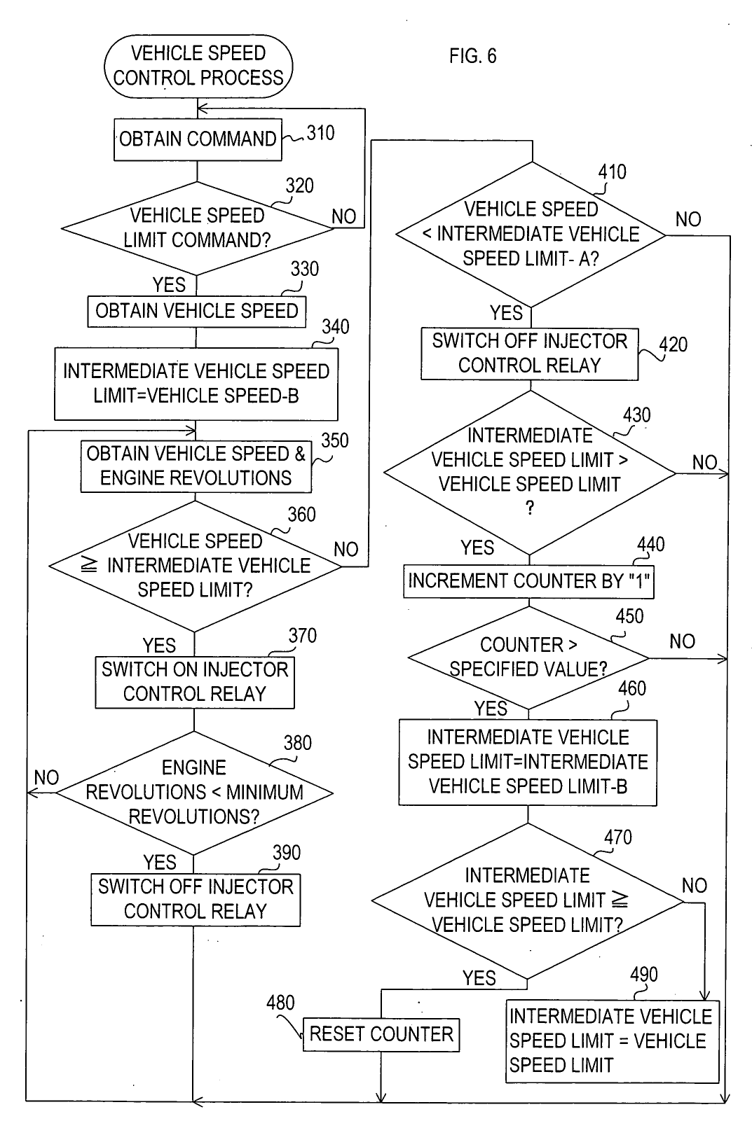

Then, the vehicle speed arithmetic control unit 22 to which the vehicle speed limit command has been input from the arithmetic control unit 11 performs the following processing as shown by the flowchart in FIG. 6.

First, the input from the arithmetic control unit 11 is checked. If it is determined that the command is a speed limit command (S320: YES), the vehicle speed is obtained from the speedometer 47 through the vehicle speed/revolution input circuit 23 (S330), and an intermediate vehicle speed limit as a value for limiting the vehicle speed is determined by subtracting a reduction amount B (e.g. 20 km/hr) from the current vehicle speed obtained in S330 (S340).

Subsequently, the current vehicle speed and the current engine revolutions are obtained, respectively, from the speedometer 47 and the engine ECU 46 through the vehicle speed/revolution input circuit 23 (S350), and it is determined whether or not the obtained vehicle speed is higher than the intermediate vehicle speed limit (S360).

Then, if it is determined that the current vehicle speed is higher than the intermediate vehicle speed limit (S360: YES), a command voltage is output from the relay drive circuit 24 to switch on the injector control relay 39, and thereby to prevent the injector from operating (S370). That is, the fuel supply to the engine is stopped.

Subsequently, it is determined whether or not the engine revolutions are lower than the minimum revolutions which are lower than idling revolutions and at which the engine is nearly stopped (S380). If it is determined that the engine revolutions are lower than the minimum revolutions, the output of the command voltage to the relay drive circuit 24 is stopped to switch off the injector control relay 39 (S390), so that the fuel supply to the engine is resumed to prevent the engine from being stopped.

Also, if the current vehicle speed is lower than the intermediate vehicle speed limit (S360: NO) and also lower than the value obtained by subtracting a speed margin A (for example, 3 km/hr) from the intermediate vehicle speed limit (S410: YES), the injector control relay 39 is switched off to resume the fuel supply to the engine.

If the intermediate vehicle speed limit is higher than a vehicle speed limit (for example, 30 km/hr) which is a target speed limit (S430: YES), a variable counter is incremented by “1” (S440). When the counter is smaller than a specified value (for example, “3”), it is waited for the counter to exceed the specified value. When the counter exceeds the specified value (S450: YES), the intermediate vehicle speed limit is set to a value obtained by subtracting the reduction amount B from the current intermediate vehicle speed limit (S460), and the counter is reset to “0” (S480). If the intermediate vehicle speed limit is lower than the vehicle speed limit (S470: NO), the intermediate vehicle speed limit is regarded as the vehicle speed limit (S490).

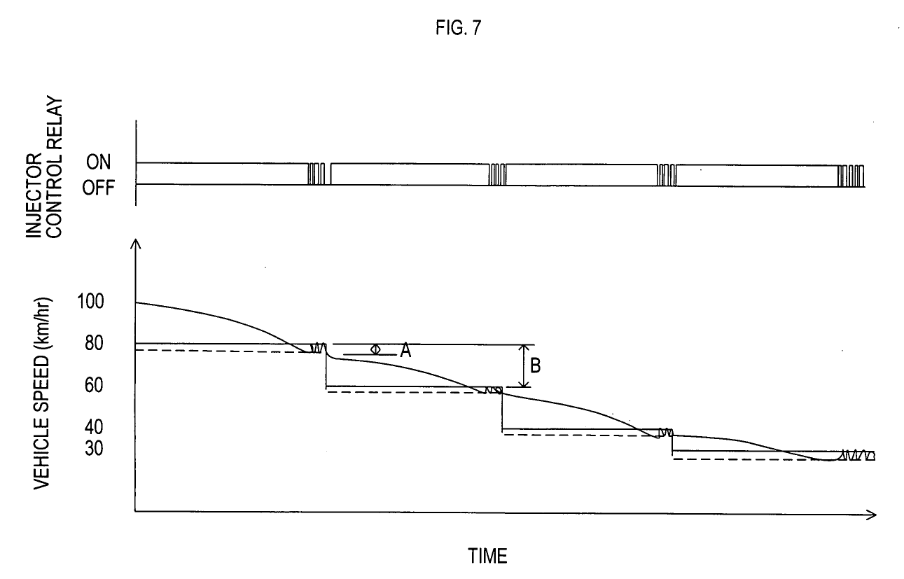

Switching on/off the fuel supply to the engine according to the above process leads to the behavior of the vehicle as shown in FIG. 7.

First, the intermediate vehicle speed limit is set to a value (80 km/hr in this case) lower than the current vehicle speed (100 km/hr in this case) by the reduction amount B. Since the current vehicle speed is higher than a value (77 km/hr) obtained by subtracting the speed margin A from the intermediate vehicle speed limit, the injector control relay 39 is switched on. Then, the fuel supply to the engine is stopped, and thereby the vehicle speed is lowered.

When the vehicle speed becomes lower than a value obtained by subtracting the speed margin A from the intermediate vehicle speed limit, the injector control relay 39 is switched off. Then, the injector is allowed to operate, and thereby the vehicle speed is increased. However, if the vehicle speed exceeds the intermediate vehicle speed limit, the injector control relay 39 is switched on again to prevent the injector from operating.

After repeating the above process a specified times (three times), a new intermediate vehicle speed limit is set to a value (60 km/hr) obtained by subtracting the reduction amount B from the former intermediate vehicle speed limit. Since the injector is not allowed to operate until the vehicle speed reaches a value obtained by subtracting the speed margin A from the new intermediate vehicle speed limit, the vehicle speed is lowered. The intermediate vehicle speed limit is set to a further lower value in the same manner until the vehicle speed reaches 30 km/hr set as the vehicle speed limit.

According to the vehicle antitheft system 1, as described above, the antitheft control apparatus 10 is set into the “alarm mode” by a signal from the remote controller 50, and then illegal acts committed against the vehicle 5 during parking, such as breaking windows, tilting the vehicle or braking into the vehicle interior are monitored. If any illegal act is detected, a siren or an alarm sound is set off and the engine of the vehicle 5 is prevented from being started. Thus, vehicle theft can be prevented.

Even if the vehicle 5 is stolen while the antitheft control apparatus 10 is not in the “alarm mode,” it is possible to send a vehicle speed limit command from the hand-held controller 60 to gradually lower the vehicle speed down to the vehicle speed limit, thereby to prevent driving at a sufficient speed. Thus, it is possible to impede escape of the vehicle thief and to stop the vehicle without obstructing the traveling of other vehicles or causing a dangerous situation by a sudden speed reduction.

Also, according to the vehicle antitheft system 1, the vehicle speed, which is limited by setting the intermediate speed limits, may be safely lowered without a rapid speed reduction.

Furthermore, if the vehicle antitheft system 1 is installed into every vehicle and the hand-held controller 60 is installed into a police car, for example, it may be possible to safely control and make a speeding vehicle drive at a low speed. Therefore, the risk of a second accident can be reduced. By using this system, a car chase between a car thief and the police as often seen, for example, in an American TV program can be changed such that the stolen car may be safely controlled so as to travel at a low speed and the car thief will be arrested.

When the fuel supply to the engine is stopped by the injector control relay 39, excessively low engine revolutions may cause the engine to be stopped. Then, there is a possibility that the driving force cannot be obtained even if the injector control relay 39 is switched off, and that the vehicle 5 is brought into a dangerous situation. In the present embodiment, however, if the engine revolutions, obtained from the engine ECU 46, are lower than the minimum revolutions, the fuel supply to the engine is resumed (S390) to increase the engine revolutions. Therefore, the engine will not be stopped and the vehicle 5 is prevented from being brought into a dangerous situation.

[Modification]

Although an embodiment of the present invention has been described as above, the present invention is not limited to the above specific embodiment, but may be practiced in various forms within the scope not departing from the gist of the present invention.

For example, the antitheft control apparatus 10 is designed such that reduction of the vehicle speed is achieved by stopping an operation signal to the injector 48 by means of the injector control relay 39 to prevent the injector 48 from operating and thereby stopping the fuel supply to the engine. However, the apparatus may be designed such that reduction of the vehicle speed is achieved by means of a brake, specifically by providing an actuator for performing braking operation or by providing a command signal to a brake assist device so as to perform braking operation.

In this regard, however, the constitution of the present embodiment that stops the operation command to the injector 48 only requires additionally providing the injector control relay 39 in the middle of the wiring. Therefore, it is easy to additionally provide the same when the vehicle antitheft system 1 is installed after the purchase of a vehicle.

While the hand-held controller 60 of the present embodiment includes the control unit 61, the input unit 62, and the output unit 63 constituted by using a PDA, the control unit 61, the input unit 62, and the output unit 63 may be respectively constituted by a personal computer main body, a keyboard and a mouse, and a display monitor of a common personal computer.

1. A vehicle antitheft system, comprising:
a monitoring device installed in a vehicle that monitors the state of the vehicle during the parking of the vehicle to detect an illegal act committed against the vehicle;
an alarm device that sets off an alarm if the monitoring device detects an illegal act committed against the vehicle;
a speed reduction device that forcibly reduces the speed of the vehicle regardless of the original vehicle operation by a driver;
a reception device that receives a speed reduction command transmitted from a command apparatus outside the vehicle; and
a vehicle speed limit device that makes the speed reduction device operate to limit the speed of the vehicle to a predetermined vehicle speed limit or lower when the reception device receives a speed reduction command.

2. The vehicle antitheft system according to claim 1, wherein the vehicle speed limit device controls the speed reduction device by setting at least one intermediate vehicle speed limit, when an initial vehicle speed at the time of receiving the speed reduction command by the reception device is higher than the vehicle speed limit by a specified amount or more, between the initial vehicle speed and the vehicle speed limit, and by stopping the speed reduction device when the vehicle speed becomes lower than the intermediate vehicle speed limit during a specified period of time since the vehicle speed reaches the intermediate vehicle speed limit, so that the vehicle speed is gradually lowered from the initial vehicle speed through the intermediate vehicle speed limit to the vehicle speed limit.

3. The vehicle antitheft system according to claim 1,
wherein the vehicle includes an internal-combustion engine,
and wherein the speed reduction device forcibly slows down the vehicle by stopping the fuel supply to the internal-combustion engine.

4. The vehicle antitheft system according to claim 3, wherein, while the vehicle is being slowed down by the operation of the speed reduction device, the vehicle speed limit device monitors the revolving speed of the internal-combustion engine and stops the operation of the speed reduction device when the revolving speed is lower than a predetermined minimum revolving speed, thereby to prevent the revolving speed of the internal-combustion engine from being lowered than the predetermined minimum revolving speed.

5. The vehicle antitheft system according to claim 1,
wherein the monitoring device includes a three-axis sensor that detects a displacement of the vehicle as one of the sensors for monitoring the state of the vehicle,
and wherein, if a displacement of the vehicle is detected by the three-axis sensor, the monitoring device determines that an illegal act has been committed and provides a detection signal indicating the detection of the illegal act to the alarm device.

6. A command apparatus provided with a transmission device that transmits various command signals from the outside of a vehicle to the vehicle antitheft system according to claim 1, the command apparatus comprising:
a speed reduction command generating device that generates a speed reduction command to the vehicle antitheft system corresponding to the command apparatus in accordance with an external operation by a user, and makes the transmission device transmit the speed reduction command.

7. A program that performs the function of the speed reduction command generating device in the command apparatus according to claim 6 by means of the processing by a microcomputer constituting an information terminal having the function as the transmission device.
